(19) United States
(12) Patent Application Publication
(10) Pub. No.: US 2023/0351082 A1
(43) Pub. Date: Nov. 2, 2023

(54) SATISFIABILITY-BASED RESUBSTITUTION FOR INCREMENTAL MAPPED OPTIMIZATION

(71) Applicant: Synopsys, Inc., Mountain View, CA (US)

(72) Inventors: Vinicius NEVES POSSANI, Sunnyvale, CA (US); Luca Gaetano AMARU, Santa Clara, CA (US); Patrick Emmanuel VUILLOD, Plateau-des-Petites-Roches (FR)

(21) Appl. No.: 18/140,226

(22) Filed: Apr. 27, 2023

Related U.S. Application Data
(60) Provisional application No. 63/336,591, filed on Apr. 29, 2022.

(51) Int. Cl. G06F 30/327

(52) U.S. Cl. CPC G06F 30/327

(57) ABSTRACT

Embodiments herein describe selecting a gate in a mapped network and then un-mapping the gate from a library cell into a Boolean expression. Resubstitution can be performed on the gate to determine whether its logic can be simplified using, e.g., a don’t care set and candidate divisors within a window of the gate. If a new Boolean expression resulting from performing resubstitution has an equivalent function, the gate can be re-mapped using the new Boolean expression, which can reduce the area of a circuit design corresponding to the mapped network. These steps can be performed iteratively on the mapped network.

### RELATED APPLICATION

This application claims priority to and the benefit of U.S. Provisional Pat. Application Serial No. 63/336,591, entitled “SAT-BASED RESUBSTITUTION FOR INCREMENTAL MAPPED OPTIMIZATION”, filed Apr. 29, 2022, which is incorporated herein by reference in its entirety.

### TECHNICAL FIELD

Embodiments presented in this disclosure generally relate to don’t-care-based resubstitution on cell mapped networks in electronic design automation (EDA).

### BACKGROUND

Boolean Satisfiability (SAT)-based optimizations determine whether there exists an assignment to variables of a given Boolean formula (e.g., a Boolean expression associated with logic circuitry in a netlist) that makes the formula produce true as output. SAT solvers includes specialized algorithms to determine whether a given SAT instance is satisfiable by producing true as output or if it is unsatisfiable by producing false as output.

Node resubstitution is a typical logic synthesis technique that can be enhanced in both scalability and quality by employing SAT-based reasoning for computing don’t-care flexibilities. Modern don’t-care-based resubstitution and remapping are able to optimize a Boolean function for logic circuitry in a local context using interpolation without explicitly computing its don’t-care set. Such techniques are interesting approaches for network resynthesis, as they perform localized network transformations to re-express the logic of a given node (gate) which can reduce the size of a netlist and save space in a circuit design. Previous solutions employed such SAT-based approaches for resynthesis after lookup table (LUT) based technology mapping. In one previous approach, the SAT-based methods are reformulated to perform versatile remapping for standard cells in the context of Application-Specific Integrated Circuits (ASICs).

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a computing system executing an EDA application, according to embodiments of the present disclosure

FIG. 2 is a flowchart of a method for performing resubstitution for a mapped network, according to embodiments of the present disclosure.

FIG. 3 is a flowchart of a method for performing resubstitution for a mapped network, according to embodiments of the present disclosure.

FIG. 4 depicts psuedo-code for performing resubstitution for a mapped network in accordance with some embodiments of the present disclosure.

FIGS. 5A-5C illustrate performing resubstitution for gates in a mapped network, according to embodiments of the present disclosure.

FIG. 6 illustrates an example set of processes used during the design, verification, and fabrication of an article of manufacture

FIG. 7 depicts a diagram of an example computer system in which embodiments of the present disclosure may operate.

### DETAILED DESCRIPTION

The embodiments herein describe performing incremental optimization on mapped networks by exploiting the flexibilities of don’t-cares computed through scalable SAT-based techniques. Embodiments herein describe an incremental and flexible approach to perform don’t-care-based resynthesis on standard-cell mapped networks integrated to multiple stages of a design flow for ASICs. In digital logic, a don’t-care term for a function is an input-sequence (e.g., a series of bits) for which the function output does not matter. In one embodiment, windowing (e.g., limiting the scope of a logic optimization) and SAT solving (e.g., determining whether there exists an assignment of variables of a given Boolean expression that makes the formula produce true as an output) are used to perform resubstitution (e.g., attempting to replace fan ins of the gate by its divisors or to remove a redundant fan in) and local function simplification driven by factored-form (FF) literal costing (e.g., a literal cost of a new Boolean expression re-expressing the node n) and followed by an incremental remapping pass.

In one embodiment, the SAT-based resubstitution and function simplification work incrementally on top of a standard cell mapped network where FF literal costing can be used in the core of the resubstitution, allowing fine-grain costing towards standard-cell based implementations. Further, embodiments herein can be integrated into a design flow to perform post-mapping global resynthesis and area-recovering after timing optimization, while applying hierarchy ungrouping after data path synthesis to enable better optimization context.

In one embodiment, the techniques herein operate on top of a general Boolean network where each internal node represents a logic function associated to a library cell. This network data structure supports representation and operations on both mapped nodes or gates (e.g., nodes or gates that have been mapped to a standard cell in a library containing a collection of low-level logic functions (or cells) such as OR, AND, invert, flip-flops, buffers, etc.) and unmapped nodes or gates (e.g., nodes or gates that are represented by a Boolean expression and have not been mapped to a library cell), as some nodes become unmapped when performing the embodiments herein. That is, a mapped network (e.g., a mapped netlist containing nodes or gates that have been mapped to library cells) can be selectively unmapped where a particular gate or node can converted into an unmapped node or gate and be optimized by resubstitution and local simplification. This avoids having to un-map the entire network.

Advantages of the present disclosure include, but are not limited to, incrementally moving from a suboptimal mapped network to a well-optimized remapped network using multiple iterations rather than performing resubstitution of each gate in the mapped network only one time. In one embodiment, the techniques described herein are applied for resynthesis and area recover that use incremental operations in the network. In one embodiment, the techniques herein can be integrated on multiple steps of an EDA application so that it works as a final refinement for a given optimization engine. The proposed incremental SAT-based optimization can be run on the global design, refining the mapped networks hierarchy by hierarchy (assuming the mapped network or netlist contains a hiararchy of modules).

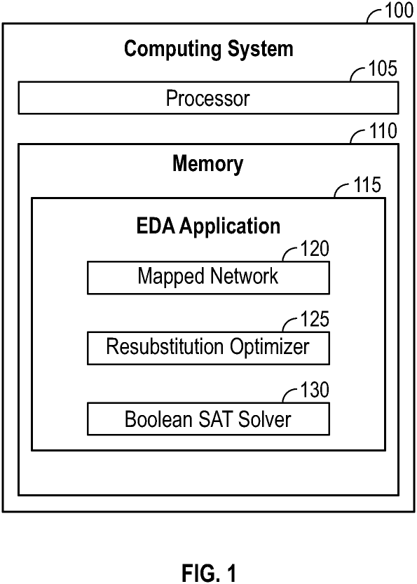

FIG. 1 illustrates a computing system 100 executing an EDA application 115, according to embodiments of the present disclosure. The computing system 100 can be a single computing device (e.g., a server) or can include multiple computing devices (e.g., a network of servers or a datacenter).

The computing system 100 includes a processor 105 which represents any number of processors that each can include any number of processor cores. The system 100 also has memory 110 which can include volatile memory elements, nonvolatile memory elements, and combinations thereof.

In this example, the memory 110 stores the EDA application 115 which is executed using the processor 105. As described in more detail below, the EDA application 115 performs don’t-care-based resubstitution (e.g., using a don’t care set to determine a replacement for a fan in or to remove a redundant fan in) on a mapped network 120. In one embodiment, the mapped network 120 is mapped netlist where the gates (or nodes) in the netlist have been mapped to a library cell. In one embodiment, the mapped network 120 does not have any unmapped gates or nodes (which are represented by a Boolean expression).

The EDA application 115 includes a resubstitution optimizer 125 that performs resubstitution to optimize the mapped network 120. As part of performing resubstitution, the mapped gates in the mapped network 120 are unmapped into Boolean expressions. However, rather than un-mapping the entire mapped network 120, the embodiments herein can un-map a selected portion (a gate) of the mapped network 120 which can save computer resources and conserve power. The resubstitution can be performed as part of an iterative process.

After performing resubstitution, a Boolean SAT solver 130 can determine whether a new, optimized Boolean expression for an un-mapped node or gate is logically equivalent (e.g., the same function) as the current Boolean expression. If so, this means the resubstitution process optimized the gate without changing the function of the gate or node. The new Boolean expression for the node or gate can then be re-mapped back into a mapped node or gate after, e.g., the remaining nodes or gates in the mapped network 120 have been evaluated by the resubstitution optimizer 125.

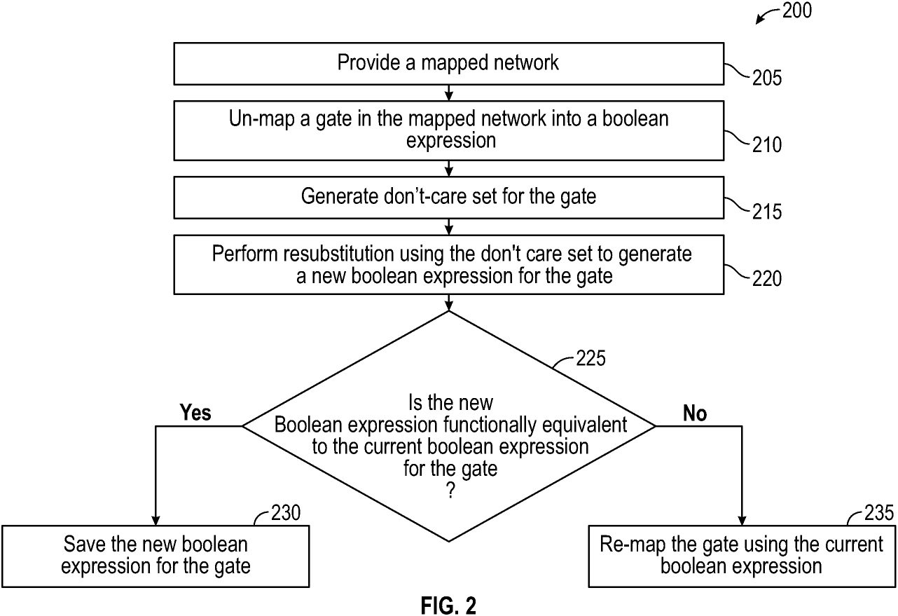

FIG. 2 is a flowchart of a method 200 for performing resubstitution for a mapped network, according to embodiments of the present disclosure. At block 205, the EDA application (e.g., the EDA application 115 in FIG. 1) provides (or generates) a mapped network (e.g., the mapped network 120 in FIG. 1) which may include a netlist of gates or nodes that have been mapped to library cells. For example, the EDA application may have previously mapped Boolean expressions representing the gates in a netlist into library cells to form the mapped network.

At block 210, the resubstitution optimizer (e.g., the resubstitution optimizer in FIG. 1) un-maps a gate in the mapped network into a Boolean expression. For example, the gate (also referred to as the target gate) may currently be a mapped gate (or mapped node) that is represented as a standard library cell (or cells). The resubstitution optimizer un-maps the gate from the library cell to a Boolean expression, which may reverse the process done earlier by the EDA application when mapping the Boolean expression into a library cell. However, the Boolean SAT optimization used later in the method 200 may rely on Boolean expressions to determine whether the resubstitution results are valid.

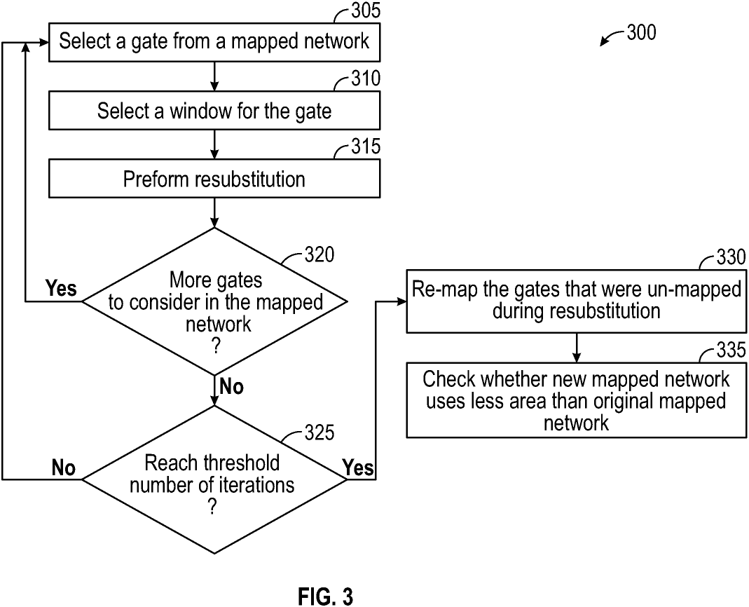

In one embodiment, the method 200 can be performed on each gate in the mapped network. For example, after completing the method 200 for one gate, the EDA application may select a different gate to perform method 200. Further, resubstitution may be performed iteratively on the mapped network. This is discussed in more detail in FIG. 3.

At block 215, the resubstitution optimizer generates a don’t-care set for the gate. They don’t-care set can include a plurality of don’t-care terms for the target gate where an input-sequence for which the target gate’s output does not matter. “Don’t cares” can happen when some Boolean values never happen at the inputs of the target gate while other “don’t cares” are produced when the output of the target gate never affects the network primary outputs (POs) due to certain conditions of the network. For example, Controllability Don’t Cares (CDC) happen when some Boolean values never happen at the inputs of the target gate and the Observability Don’t Cares (ODC) are produced when the output of the target gate never affects the network POs due to certain conditions of the network. In one embodiment, the resubstitution optimizer formulates a SAT instance in Conjunctive-Normal Form (CNF) format to compute the don’t-care flexibilities of the gate.

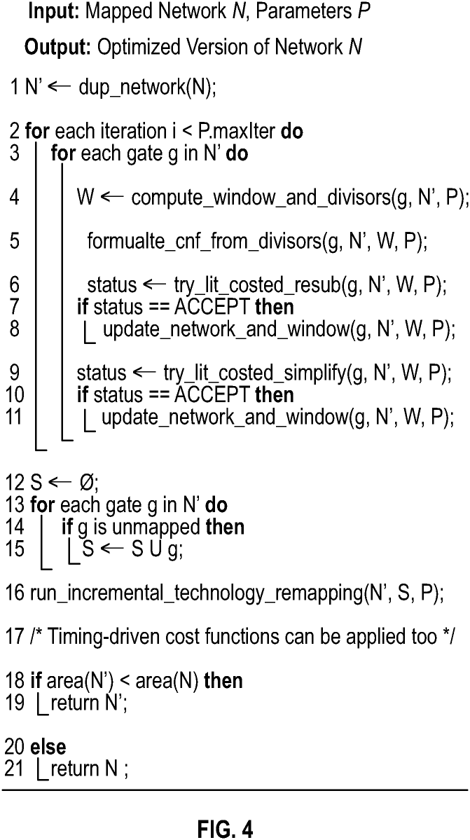

At block 220, the resubstitution optimizer performs resubstitution using the don’t-care set to generate a new Boolean expression for the gate. In one embodiment, resubstitution includes performing multiple attempts to replace fan ins of the gate by its divisors or to remove a redundant fan in. The divisors are other candidate gates that can be reconnected to the target gate to replace the redundant fan in. Stated differently, resubstitution is trying to reconnect some of the fan in of the target gate to another gate (e.g., a candidate divisor) to make existing gates have zero fan outs so these gates can be removed. Additional details for performing resubstitution are provided when discussing FIG. 4 below.

At block 225, the Boolean SAT solver (e.g., the Boolean SAT solver in FIG. 1) determines whether the new (optimized) Boolean expression for the target gate is functionally equivalent to the current Boolean expression for the gate. The Boolean SAT solver may compare the Boolean expression resulting from un-mapping the target gate at block 210 with the new Boolean expression resulting from performing the resubstitution at block 220.

If the Boolean expressions are functionally equivalent (e.g., have the same outputs when receiving the same inputs), the method 200 proceeds to block 230 where the EDA application saves the new Boolean expression for the gate. In some embodiments, the EDA application may not immediately re-map the gate into a mapped gate using the new Boolean expression. As discussed in FIG. 3, the EDA application may wait until evaluating the entire mapped network at least once (if not multiple iterations) before re-mapping the gates that have been assigned new Boolean expressions back into mapped gates.

Returning to block 225, if the new Boolean expression is not functionally equivalent to the current Boolean expression, the method 200 instead proceeds to block 235 where the EDA application re-maps the gate using the current Boolean expression. Put differently, the new Boolean expression may be ignored or discarded and the gate can be re-mapped to the same library cell as when the method 200 started.

FIG. 3 is a flowchart of a method 300 for performing resubstitution for a mapped network, according to embodiments of the present disclosure. The method 300 assumes that the EDA application has received or generated a mapped network. At block 305, the EDA application selects a gate (e.g., a target gate) from the mapped network.

At block 310, the EDA application selects a window for the selected gate. In one embodiment, the window is a partition of the mapped network (the netlist) close to the selected gate, such as one or two levels of the fan in and fan out of the gate. The size of the window (e.g., the number of levels of fan in and fan out in the window) can be a customizable parameter. The candidate divisors that are used to perform resubstitution as discussed above may be limited to logic within the window. Put differently, the divisors are other gates in the window that can be connected to the target gate.

At block 315, the resubstitution optimizer performs resubstitution on the target gate. Block 315 can include the blocks 210-235 of the method 200 where the resubstitution optimizer un-maps the gate, generates a don’t-care set of the gate, generates a new Boolean expression for the gate, and determines whether the new Boolean expression is functionally equivalent to the current Boolean expression for the gate. If the resubstitution results in a new (optimized) Boolean expression for the gate, the new Boolean expression can be saved; otherwise, it can be discarded.

At block 320, the EDA application determines whether there are more gates to consider in the mapped network. If the application has yet to perform resubstitution on the entire mapped network, the method 300 returns to block 305 to select another target gate and repeat blocks 310 and 315.

However, if each of the gates in the mapped network have been considered, the method 300 proceeds to block 325 where the EDA application determines whether a threshold number of iterations has been reached. For example, the number of iterations for iterating through the mapped network to perform resubstitution can be a user configurable parameter. More iterations may result in more successful resubstitutions, but at the expense of using more computing resources and time.

After reaching the threshold number of iterations, the method 300 proceeds to block 330 where the EDA application re-maps the gates that were un-mapped during resubstitution. That is, the gates where resubstitution resulted in new (improved) Boolean expressions are re-mapped back into library cells using the new Boolean expressions. As such, in this example, the gates that are assigned new Boolean expressions when performing resubstitution at block 315 are not re-mapped until after the threshold number of iterations are reached. However, this is not a requirement.

At block 335, the EDA application checks whether the new mapped network containing the gates that were re-mapped using new Boolean expressions and the gates where their Boolean expression did not change (e..g, resubstitution was not successful) uses less area than the original mapped network. Although it is expected that resubstitution will result in less gates, and thus, less area, there is a chance that a new mapped network where resubstitution was successful for at least one gate may not save area relative to the original mapped network. Thus, at block 335 the EDA application checks to determine whether the new mapped network saves area before replacing the original mapped network with the new mapped network. Otherwise, the new mapped network is discarded.

FIG. 4 depicts pseudo-code for performing resubstitution for a mapped network in accordance with some embodiments of the present disclosure. In one embodiment, the pseudo-code in FIG. 4 corresponds to the blocks of the methods 200 and 300 in FIGS. 2 and 3.

As depicted by the pseudo-code in FIG. 4, the EDA application performs an iterative loop for multiple optimization passes in topological order trying to apply the resubstitution, (also referred to as “resub”), and simplification at each logic gate in a received mapped Network N. When evaluating a gate g (e.g., a target gate), a window W is computed by collecting nodes from some levels in the TFI and TFO of gate g. The candidate divisors for applying resubstitution for gate g are computed based on gates belonging to the window W collected from the TFI and TFO of gate g.

The window W and its annotations of candidate divisors for gate g are used to formulate a SAT instance in CNF format to compute the don’t-care flexibilities by mitering, which checks for equivalency. That is, simulation and mitering techniques can be used to determine the don’t-care set for gate g as well as to proof using Boolean SAT optimization to determine whether a resubstitution operation is feasible.

Other resynthesis methods focus mainly on networks mapped into k-input LUTs, where they control the number of divisors (fan ins) to re-express the new Boolean function for a given node, ensuring it is feasible to be implemented in a k-input LUT. However, in the context of standard library cell based resubstitution, FF literal costing (or an AND Inverter Graph (AIG) node count) are helpful to assess the benefits of a given resubstitution operation. As such, the embodiments herein can use FF literal costing in the core of the SAT-based optimizations to perform fine grain control of the added/removed literals for every network transformation attempt.

After formulating the CFN format from the divisors at line 5 of the pseudo-code, at line 6 the auxiliary function try-lit-costed-resub performs multiple attempts to replace the fan ins of gate g by its divisors or to remove a redundant fan in. Un-mapping the gate g into its Boolean expression can also be performed as part of auxiliary function try-lit-costed-resub.

If the resubstitution operation proves to be valid (e.g., the new Boolean expression generated at line 6 is functionally equivalent to the current or original Boolean expression of the gate g when it was un-mapped), then the logic function of gate g is re-expressed by reconnecting the fan in of gate g and deriving the new function using interpolation. At this point, the benefits of accepting such a resubstitution operation by deriving a FF and performing literal costing for the outcomes of the resubstitution can be assessed. The EDA application can take into account both the literal cost of the new Boolean function re-expressing gate g as well the literal cost of the Maximum-Fanout-Free Cone (MFFC) of zero-fan out gates being removed due to the resubstitution operations.

At line 9 of the pseudo-code, the flexibilities provided by don’t cares can be exploited to simplify the logic function of gate g independently of resubstitution opportunities for replacing or deleting any fan in of gate g. Put differently, the function try-lit-costed-simplify is an optional function that can also be executed to simplify the target gate g. For example, FF literal costing can determine a cost of a new Boolean expression re-expressing the target gate g. Depending on the don’t-care conditions of gate g, a simpler Boolean function representation with fewer FF literal count can be directly obtained by interpolation followed by factorization. The function try-lit-costed-simplify performs this type of local function simplification also guided by costing literal count of the current versus the new implementation of gate g.

Besides the explicit benefits of reducing literal cost for a local function, resubstitution (performed at line 6) and local simplification (performed at line 9) contribute to diversification when exploring the solution space in the next iterations of the pseudo-code. When a given resub or local simplification is accepted, then the network, the window, and the CNF are properly updated with the new implementation to re-express gate g.

When the iterative loop at lines 2 - 11 of the pseudo-code ends, the network N′ is a hybrid design, including both mapped and unmapped nodes according to the outcomes of the resubstitution and local simplification operations. In one embodiment, the method preserves (saves) the mapped gates that were not modified by the iterative optimization loop. This way, only the subset of optimized nodes that are unmapped are collected and an incremental technology mapping pass for such a subset of nodes can be performed, as shown at lines 12 -16 of the pseudo-code. The incremental technology mapper can run area-driven and/or timing-driven mapping according to the user-specified parameters P. Finally, at lines 18-21, the EDA application compares the area of the two fully mapped networks N and N′, accepting or rejecting the overall result of the optimization. That is, if the new mapped network N′ (which includes at least one gate where resubstitution was successfully performed) does not have a smaller area or footprint than the original mapped network N received as an input, then the original mapped network N is maintained and the new mapped network N′ can be discarded.

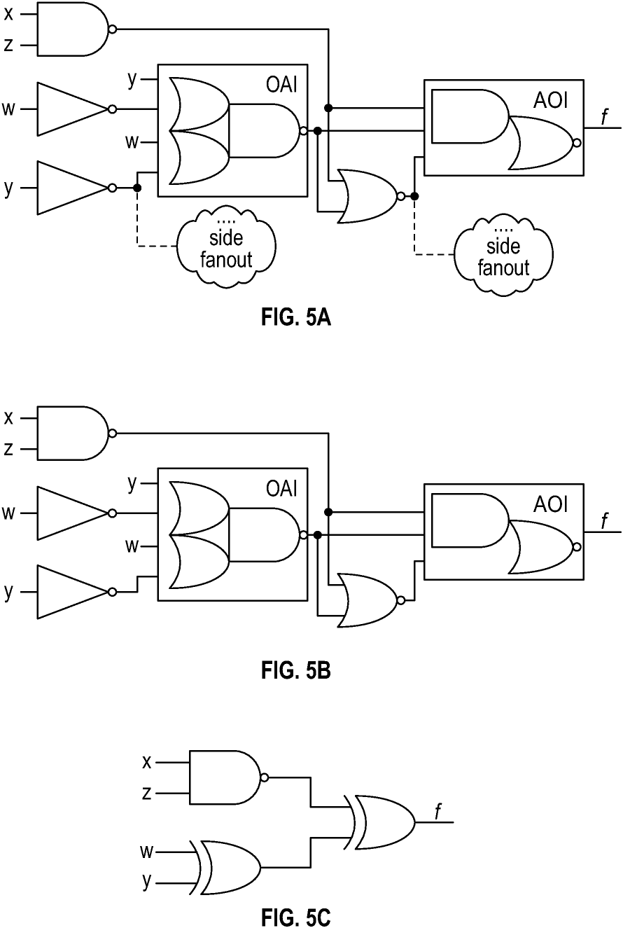

FIGS. 5A-5C demonstrate how resubstitution can help to resynthesize a mapped network when performing multiple iterations. The network of FIG. 5A is a zoomed spot of a small set of gates in a larger network with some side fan outs. As multiple iterations of resubstitution as discussed in FIGS. 3-4 gradually reconnect the fan in/fan outs of some nodes, then new opportunities for resubstitution and MFFC deletion might appear during the iterative optimization loop. For example, assume that the side fan outs of FIG. 5A are removed in a previous iteration of resubstitution which results in the network shown in FIG. 5B. Therefore, multiple opportunities to apply resubstitution are enabled for the AND-OR-INV (AOI) and the OR-AND-INV (OAI) nodes shown in FIG. 5A, finally resulting in a resynthesized network with a better mapping solution as shown in FIG. 5B.

The example in FIGS. 5A-5C illustrates how the proposed approach can incrementally move from a suboptimal mapped network to a well-optimized remapped network using multiple iterations rather than performing resubstitution of each gate in the mapped network only one time. In one embodiment, the method is applied for resynthesis and area recover that use very incremental operations in the network.

As explained above, the EDA application can perform area-driven optimization to resynthesize a mapped network incrementally. In one embodiment, the techniques above can be integrated on multiple steps of the EDA application so that it works as a final refinement for a given optimization engine. The proposed incremental SAT-based optimization can be run on the global design refining the mapped networks hierarchy by hierarchy (assuming the mapped network or netlist contains a hiararchy of modules). Moreover, allowing hierarchical ungrouping (which is discussed in more detail below) can enable more optimization opportunities by providing a better context for the don’t-care-based optimizations.

In one embodiment, the don’t-care based optimization discussed above can be used as an area-recovery strategy in different stages of the flow when running timing optimization engines. That is, the proposed resubstitution and local function simplification shown in FIG. 4 can help to gradually achieve a better mapping solution by mitigating area overheads after timing driven transformations in a given logic cone. Even though FIG. 4 is directed to literal count and area costing, the application of this algorithm can be surrounded by other methods that are both timing-driven and area-driven, contributing to the overall balance between timing and area delivered after applying the area-recovering strategy. In addition, the incremental technology mapping described above can run in timing-driven mode as well.

The embodiments here can work incrementally by changing only a subset of nodes optimized due to resubstitution or function simplification. Therefore, the embodiments herein ensure that the network gates that are already optimized for area and timing as well as are already mapped and placed are preserved, performing remapping and placement only on the identified subset of nodes. In this context, the literal costing in the core of the SAT-based engines permits the techniques above to be selective by accepting only the optimization moves that truly have the chance to refine the network incrementally.

Returning to hierarchically ungrouping, the synthesis of hierarchical designs can manage hierarchy ungrouping properly according to different stages of the design flow to maximize the opportunities for Quality of Results (QoR) improvements. Large netlists and mapped networks can include a hierarchy of modules rather than having a “flat” circuit design. During some steps of the flow, it is desirable to have the boundaries between these modules (e.g., these hierarchies) for efficient manipulation and synthesis of specialized design blocks such as design-ware and data path hierarchies. However, it may also be desirable to enable hierarchy ungrouping in later stages of the flow to expose more cell instances to the same context. Performing small hierarchy ungrouping after timing optimization and data path synthesis before performing the methods 200 and 300 in FIGS. 2 and 3 (or before performing the pseudo-code in FIG. 4) can provide a better context among the small hierarchies and the parent hierarchy. Hierarchy ungrouping can include removing the boundaries between the hierarchy or modules to generate a flat netlist or network.

When applied to a better context, the area recovery and resynthesis have more opportunities to refine the mapped networks boosting QoR. Such a small hierarchy ungrouping can be controlled by applying the ungrouping only for a subset of cases where the number of cell instances of the hierarchy is smaller than a given threshold. This enables a balanced approach and better optimization context while preserving large boundaries that contribute for QoR convergence and scalability when manipulating large designs.

The embodiments herein delivers consistent area and cell count benefits by gradually refining the mapped networks. In some instances, an average of -1.6% in combinational cell area and -5.9% in cell count was observed. The proposed area-recovering approach has demonstrated an increase of 0.4% in the average Worst Negative Slack (WNS), however, delivering consistent improvement in Total Negative Slack (TNS) with an average reduction of -8.3%. The overall runtime of the proposed flow is affordable as it relies on scalable modern techniques, leading to an average runtime increasing of only 0.5% to the flow.

In sum, the embodiments herein describe an incremental approach to exploit don’t-care-based optimization in mapped networks. The proposed approach employs scalable SAT-based techniques to compute flexibilities of don’t cares when performing node resubstitution and logic function simplification. These SAT-base techniques can be integrated to work synergistically with other engines in a commercial design flow aiming area recovery in an incremental and constructive way.

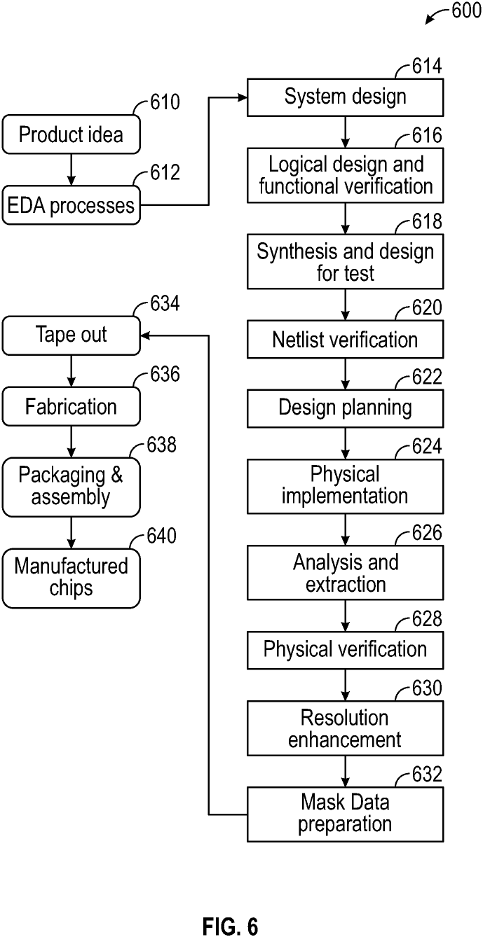

FIG. 6 illustrates an example set of processes 600 used during the design, verification, and fabrication of an article of manufacture such as an integrated circuit to transform and verify design data and instructions that represent the integrated circuit.

Each of these processes can be structured and enabled as multiple modules or operations. The term ‘EDA’ signifies the term ‘Electronic Design Automation.’ These processes start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

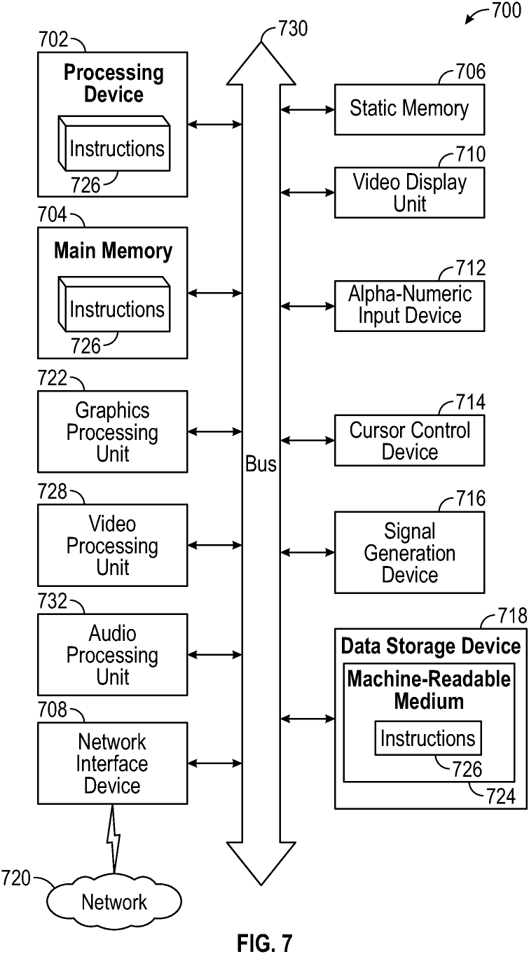

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet.

The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system’s registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
selecting a gate in a mapped network;
un-mapping the gate into a current Boolean expression;
generating a don’t-care set for the gate that includes a plurality of don’t-care terms where an input sequence for a target gate does not affect an output functionality of another gate in the mapped network;
performing, by a processing device, resubstitution using the don’t care set to generate a new Boolean expression for the gate; and
responsive to determining that the new Boolean expression is functionally equivalent to the current Boolean expression, re-mapping the gate into a mapped gate based on the new Boolean expression.

2. The method of claim 1, further comprising:
performing resubstitution for each gate in the mapped network to determine whether a resulting new Boolean expression is functionally equivalent to a respective, current Boolean expression.

3. The method of claim 2, further comprising:
performing resubstitution for each gate in the mapped network over multiple iterations.

4. The method of claim 3, further comprising:
identifying, over the multiple iterations, multiple gates in the mapped network that have new Boolean expressions that are functionally equivalent to current Boolean expressions;
re-mapping the multiple gates to mapped nodes responsive to completing the multiple iterations.

5. The method of claim 1, further comprising, before performing resubstitution:
identifying a window for the gate, the window comprising one or more levels of fan in of the gate and one or more levels of fan out for the gate; and
identifying, from within the window, divisors to be used when performing resubstitution.

6. The method of claim 1, wherein un-mapping the gate comprises un-mapping the gate from a library cell to the current Boolean expression.

7. The method of claim 1, wherein generating the don’t-care set comprises:
formulating a SAT instance in a Conjunctive-Normal Form (CNF) format.

8. The method of claim 1, wherein performing resubstitution comprises:
performing factored-form (FF) literal costing, wherein the FF literal costing comprises a literal cost of the new Boolean expression re-expressing the gate and the literal cost of a Maximum-Fanout-Free Cone (MFFC) of zero-fan out gates being removed in response to performing resubstitution.

9. The method of claim 1, wherein, after performing resubstitution, a design of a circuit defined by the mapped network is a hybrid design that comprises both mapped and unmapped nodes.

10. The method of claim 1, further comprising:
performing, after performing resubstitution, local function simplification on the gate using factored-form (FF) literal costing.

11. A system, comprising:
a processor; and
a memory containing a program which when executed by the processor performs an operation comprising:
selecting a gate in a mapped network;
un-mapping the gate into a current Boolean expression;
identifying a divisor within a window associated with the gate;
performing resubstitution to generate a new Boolean expression for the gate using the divisor; and
responsive to determining that the new Boolean expression is functionally equivalent to the current Boolean expression, re-mapping the gate into a mapped gate based on the new Boolean expression.

12. The system of claim 11, wherein the operation comprises:
performing resubstitution for each gate in the mapped network to determine whether a resulting new Boolean expression is functionally equivalent to a respective, current Boolean expression.

13. The system of claim 12, wherein the operation comprises:
performing resubstitution for each gate in the mapped network over multiple iterations;
identifying, over the multiple iterations, multiple gates in the mapped network that have new Boolean expressions that are functionally equivalent to current Boolean expressions; and
re-mapping the multiple gates to mapped nodes only after completing the multiple iterations.

14. The system of claim 13, wherein the operation comprises, before performing resubstitution:
identifying a window for the gate, the window comprising one or more levels of fan in of the gate and one or more levels of fan out for the gate; and
identifying, from within the window, divisors to be used when performing resubstitution.

15. A non-transitory computer-readable storage medium having computer-readable program code embodied therewith, the computer-readable program code executable by a processor to perform an operation comprising:
(i) selecting a gate in a mapped network;
(ii) un-mapping the gate into a current Boolean expression;
(iii) performing resubstitution for the gate to generate a new Boolean expression for the gate; and
(iv) responsive to determining that the new Boolean expression is functionally equivalent to the current Boolean expression, re-mapping the gate into a mapped gate based on the new Boolean expression; and
(v) repeating (i)-(iv) for each gate in the mapped network over multiple iterations until reaching a threshold number of iterations.

16. The non-transitory computer-readable storage medium of claim 15, wherein the operation comprises:
identifying, over the multiple iterations, multiple gates in the mapped network that have new Boolean expressions that are functionally equivalent to current Boolean expressions; and
re-mapping the multiple gates to mapped nodes responsive to completing the multiple iterations.

17. The non-transitory computer-readable storage medium of claim 15, wherein the operation comprises, before performing resubstitution:
identifying a window for the gate, the window comprising one or more levels of fan in of the gate and one or more levels of fan out for the gate; and
identifying, from within the window, divisors to be used when performing resubstitution.

18. The non-transitory computer-readable storage medium of claim 15, wherein un-mapping the gate comprises un-mapping the gate from a library cell to the current Boolean expression.

19. The non-transitory computer-readable storage medium of claim 15, wherein performing resubstitution comprises:
performing factored-form (FF) literal costing, wherein the FF literal costing comprises a literal cost of the new Boolean expression re-expressing the gate and the literal cost of a Maximum-Fanout-Free Cone (MFFC) of zero-fan out gates being removed in response to performing resubstitution.

20. The non-transitory computer-readable storage medium of claim 15, wherein the operation comprises:
performing, after performing resubstitution, local function simplification on the gate using factored-form (FF) literal costing.
